(19) United States
(12) Patent Application Publication
(10) Pub. No.: US 2016/0171403 A1
(43) Pub. Date: Jun. 16, 2016

(54) SYSTEM FOR MODELING ENERGY CONSERVATION MEASURES AND METHOD OF OPERATION THEREOF

(71) Applicant: KONINKLIJKE PHILIPS N.V., Eindhoven (NL)

(72) Inventors: ERIC BERTRAND SHEN, Croton-on-Hudson, NY (US); SAEED REZA BAGHERI, Croton-on-Hudson, NY (US); YAO-JUNG WEN, CONCORD, CA (US); YUN GU, OSSINING, NY (US); SIRISHA RANGAVAJHALA, WHITE PLAINS, NY (US)

(21) Appl. No.: 14/907,305

(22) PCT Filed: Aug. 4, 2014
(86) PCT No.: PCT/IB2014/063669

§ 371 Date: Jan. 25, 2016

Related U.S. Application Data
(60) Provisional application No. 61/862,618, filed on Aug. 6, 2013.

(51) Int. Cl. G06Q 10/06; G06Q 50/06

(52) U.S. Cl. CPC G06Q 10/06312; G06Q 50/06

(57) ABSTRACT

A system (700) having at least one controller (710) which may obtain space attribute information (103) including information related to identity, use type, square area, occupant density, and daylight illumination a plurality of spaces of a building; cluster (109) the plurality of spaces into one or more classes in accordance with energy consumption and energy savings potentials of the plurality of spaces, wherein each class has class attributes which define the class; determine a priority value (113) for each of the one or more classes based upon the class attributes of each class of the one or more classes; and assign one or more sensors (115) of a plurality of sensors (760) to one or more classes in accordance with the determined priority value for each corresponding class of the plurality of classes.

The present system relates to a system which may model energy conservation measures (ECMs) for a building and, more particularly, to a system which may efficiently determine energy use of a building using extrapolation methods and a method of operation thereof.

As the price of energy increases, it has become ever more desirable to implement energy conservation measures (ECMs) in buildings such as energy efficient lighting and lighting controls. However, to determine which ECMs are best for a particular use such as for a building, it is important to estimate the potential energy savings for many different lighting and control setups and manually determine a best fit. This prior system requires a manually-performed on-site survey of the building (e.g., by a building auditor) to be performed and information gathered for analysis to obtain a first order estimate of required ECMs. Unfortunately, this process is time consuming, unscalable, and costly. Further, because of the many different combinations, conventional analysis may take hours if not days of calculation time. Accordingly, using conventional energy analysis methods, it is difficult if not impossible to change ECM or other variables in real time.

The system(s), device(s), method(s), user interface(s), computer program(s), processes, etc. (hereinafter each of which will be referred to as system or the system, unless the context indicates otherwise) described herein address problems in prior art systems. Embodiments of the present system may detect energy use, predict energy use of a structure such as a building (hereinafter each of which will be commonly referred to as building for the sake of clarity).

In accordance with embodiments of the present system, there is disclosed a system including at least one controller which may obtain space attribute information (SAI) including information related to identity (ID), use type, square area (area²), occupant density, and/or daylight illumination for a plurality of spaces of the building. The at least one controller may then cluster the plurality of spaces into one or more classes in accordance with energy consumption and energy savings potentials of the plurality of spaces, wherein each class has class attributes which define the class. Further, the at least one controller may determine a priority value for each of the one or more classes based upon the class attributes of each class of the one or more classes. Moreover, the at least one controller may assign one or more sensors of a plurality of sensors to one or more classes in accordance with the determined priority value for each corresponding class of the plurality of classes, the one or more sensors each may be configured to detect one or more of occupancy, switch status, and light level information at the corresponding sensor and form corresponding sensor information. In some embodiments, the sensors may be coupled to, or include, a light switch which may control an illumination source such as a light bulb in the corresponding space of the plurality of spaces of the building.

It is also envisioned that the at least one controller may further determine a space of the plurality of spaces of the building to place each sensor of the plurality of sensors in accordance with at least the assignment of the one or more sensors. It is further envisioned that the at least one controller may acquire the sensor information from each of the plurality of sensors. The at least one controller may further determine baseline energy use information (BEUI) and/or energy savings information (ESI) for at least one energy conservation mode (ECM) for each class which is assigned one or more sensors of the plurality of classes based upon the received sensor information. It is also envisioned that the at least one controller may determine for each class of the plurality of classes that are assigned sensors, mean energy use density information (EUDI) and energy savings density information (ESDI) for the at least one ECM in accordance with at the BEUI and the ESI for the corresponding class of the plurality of classes. It is also envisioned that the at least one controller may determine one or more of baseline energy consumption for the building and an energy savings for the at least one ECM for the building based upon at least one of the EUDI and the ESDI.

In accordance with yet further embodiments of the present system there is disclosed a method of determining energy use in a building having a plurality of spaces covering a square area (area²), the method performed by at least one controller and may include one or more acts of: obtaining space attribute information (SAI) including information related to identity (ID), use type, square area, occupant density, and daylight illumination for a plurality of spaces of the building; clustering the plurality of spaces into one or more classes in accordance with energy consumption and energy savings potentials of the plurality of spaces, wherein each class has class attributes which define the class; determining a priority value for each of the one or more classes based upon the class attributes of each class of the one or more classes; and assigning one or more sensors of a plurality of sensors to one or more classes in accordance with the determined priority value for each corresponding class of the plurality of classes, the one or more sensors each configured to detect one or more of occupancy, switch status, and light level information in the vicinity of the corresponding sensor and form corresponding sensor information.

In accordance with yet other embodiments of the present system, the method may further include acts of determining a space of the plurality of spaces of the building to place each sensor of the plurality of sensors in accordance with at least the assignment of the one or more sensors; and/or acquiring sensor information from each of the plurality of sensors. The method may further include an act of determining baseline energy use information (BEUI) and energy savings information (ESI) for at least one energy conservation mode (ECM) for each class which is assigned one or more sensors of the plurality of classes based upon the received sensor information received from sensors assigned to the corresponding class of the plurality of classes. It is also envisioned that the method may include an act of determining, for each class of the plurality of classes that are assigned sensors, mean energy use density information (EUDI) and energy savings density information (ESDI) for the at least one ECM in accordance with at the BEUI and the ESI for the corresponding class of the plurality of classes. The method may further include an act of determining one or more of baseline energy consumption for the building and an energy savings for the at least one ECM for the building based upon at least one of the EUDI and the ESDI.

In accordance with yet further embodiments of the present system, there is disclosed a computer program stored on a computer readable memory medium, the computer program may be configured to generate information indicative of energy use in a building having a plurality of spaces each having a square area (area²), the computer program may include a program portion configured to: obtain space attribute information (SAI) including information related to identity (ID), use type, square area, occupant density, and daylight illumination for each of the plurality of spaces of the building; cluster each of the plurality of spaces into one or more classes in accordance with energy consumption and energy savings potentials of each of the plurality of spaces, wherein each class has class attributes which define the class; determine a priority value for each of the one or more classes based upon the class attributes of each class of the one or more classes; and/or assign one or more sensors of a plurality of sensors to one or more classes in accordance with the determined priority value for each corresponding class of the plurality of classes, the one or more sensors each configured to detect one or more of occupancy, switch status, and light level information in the vicinity of the corresponding sensor and form corresponding sensor information.

In accordance with yet other embodiments of the present system, the program portion may be further configured to determine a space of the plurality of spaces of the building to place each sensor of the plurality of sensors in accordance with at least the assignment of the one or more sensors; and/or acquire sensor information from each of the plurality of sensors.

It is further envisioned that the program portion may be further configured to determine baseline energy use information (BEUI) and energy savings information (ESI) for at least one energy conservation mode (ECM) for each class which is assigned one or more sensors of the plurality of classes based upon the received sensor information received from sensors assigned to the corresponding class of the plurality of classes. It is also envisioned that the program portion may be further configured to determine, for each class of the plurality of classes that are assigned sensors, mean energy use density information (EUDI) and energy savings density information (ESDI) for the at least one ECM in accordance with at the BEUI and the ESI for the corresponding class of the plurality of classes. It is also envisioned that the program portion may be further configured to determine one or more of baseline energy consumption for the building and an energy savings for the at least one ECM for the building based upon at least one of the EUDI and the ESDI.

In accordance with yet other embodiments of the present system, there is disclosed a system which may include at least one controller which may be configured to: obtain space-type attribute information (STI) including information related to floor type, zone type, window/wall ratio (WWR), glazing type, use type, and desired energy conservation mode (ECM) for each of a plurality of spaces in a building, each of the plurality of spaces covering a corresponding square area of space in the building; determine one or more of occupancy, lighting, and plug load profiles for the STI for each space of the plurality of spaces; build energy use index (EUI) models in accordance with one or more of the STI and the plug load profiles for the STI to represent base energy use and a ECM for each space of the plurality of spaces of the building; select an EUI for each space from the EUI models based upon determine energy consumption for each space by multiplying the selected EUI for each space by the square area of the corresponding space of the plurality of spaces; and/or may estimate energy consumption for the building based upon a summation of the determined energy consumption for each space of the plurality of spaces.

The invention is explained in further detail, and by way of example, with reference to the accompanying drawings wherein:

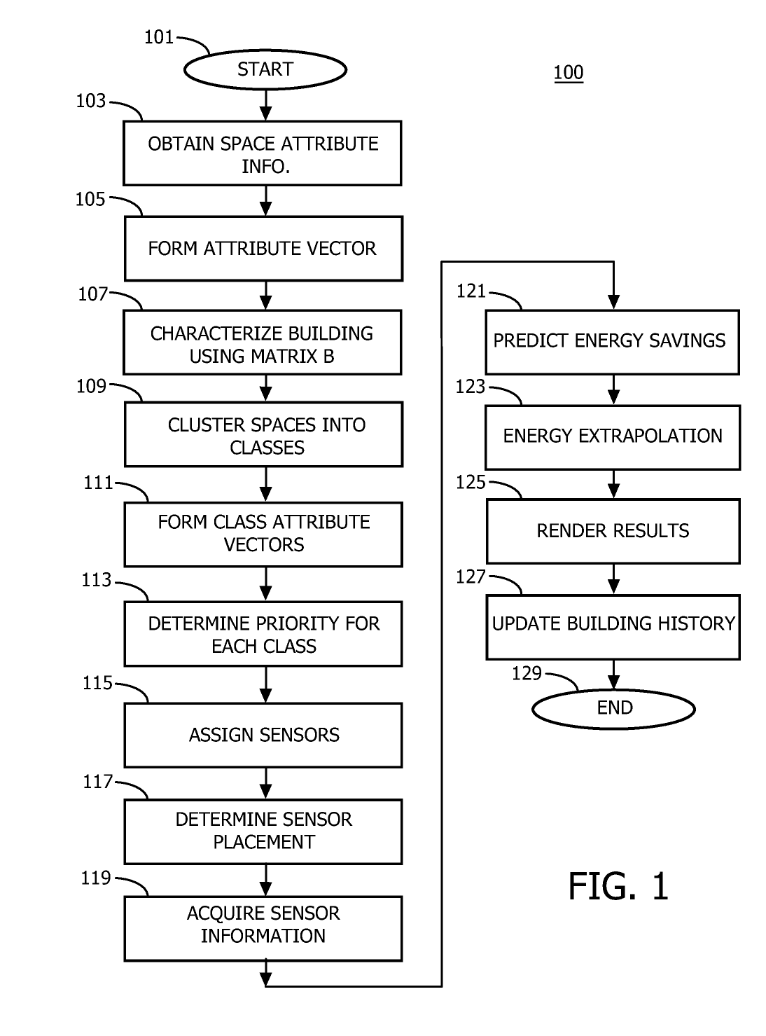

FIG. 1 shows a flow diagram that illustrates a process performed by an energy analysis system in accordance with embodiments of the present system;

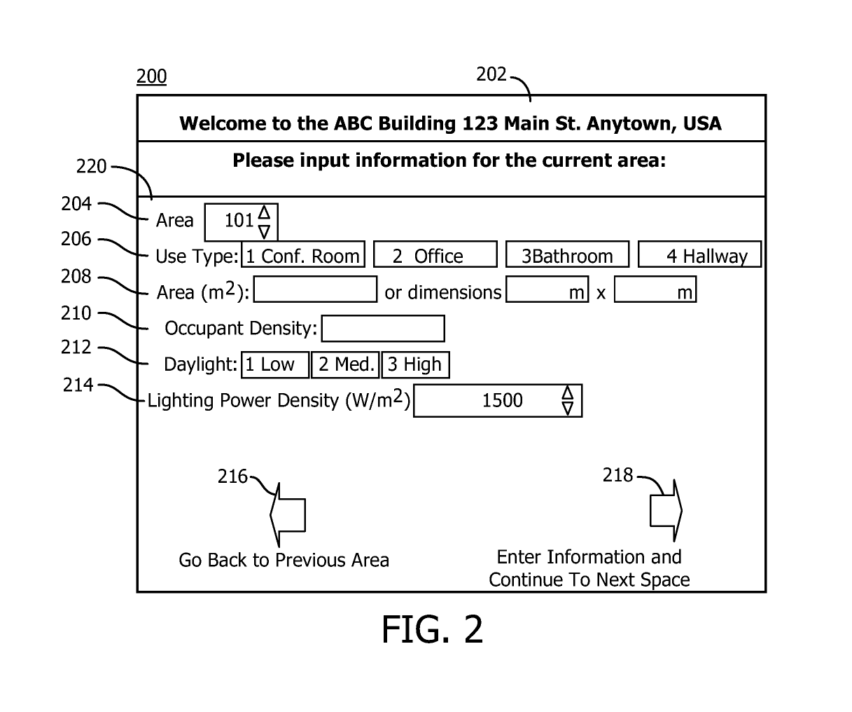

FIG. 2 shows a UI rendered in accordance with embodiments of the present system;

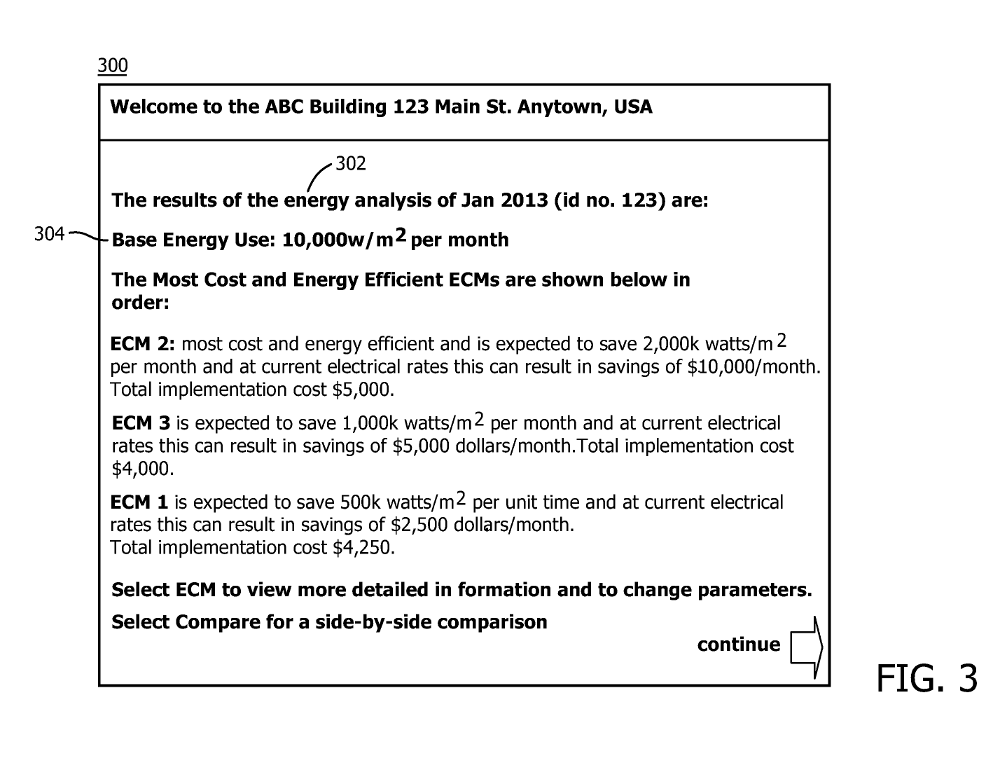

FIG. 3 shows a user interface including results of the process and rendered on a display of the system in accordance with embodiments of the present system;

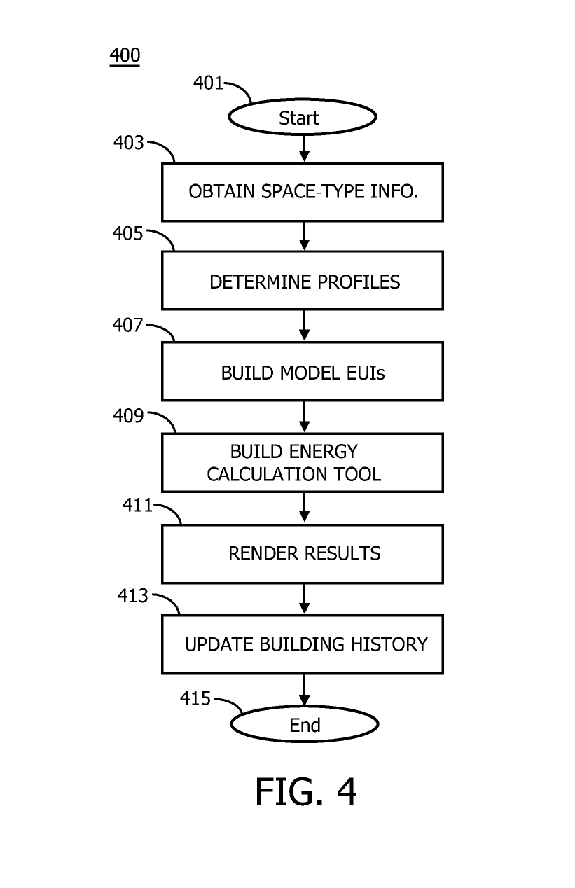

FIG. 4 shows a flow diagram that illustrates a process performed by an energy analysis system in accordance with embodiments of the present system;

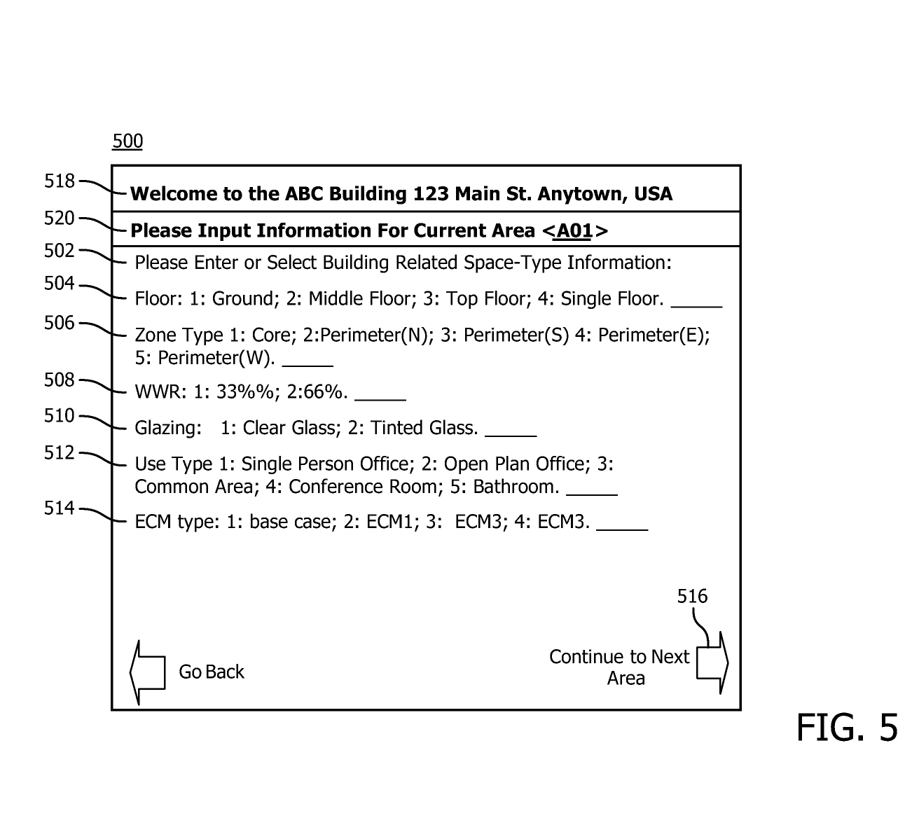

FIG. 5 shows a UI rendered in accordance with embodiments of the present system;

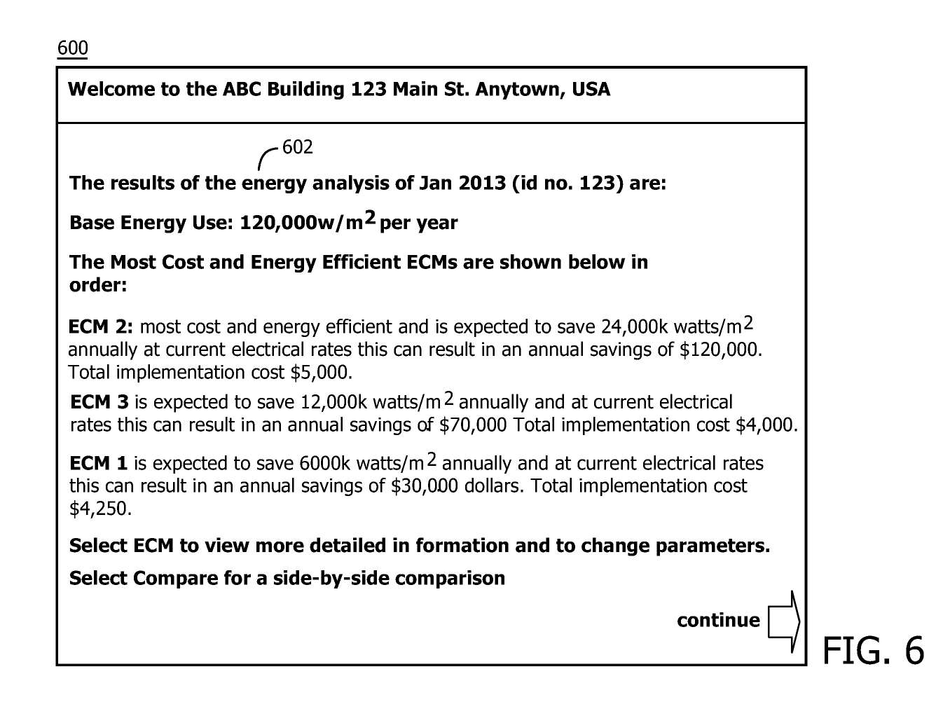

FIG. 6 shows a UI including results of the process and rendered on a display in accordance with embodiments of the present system; and

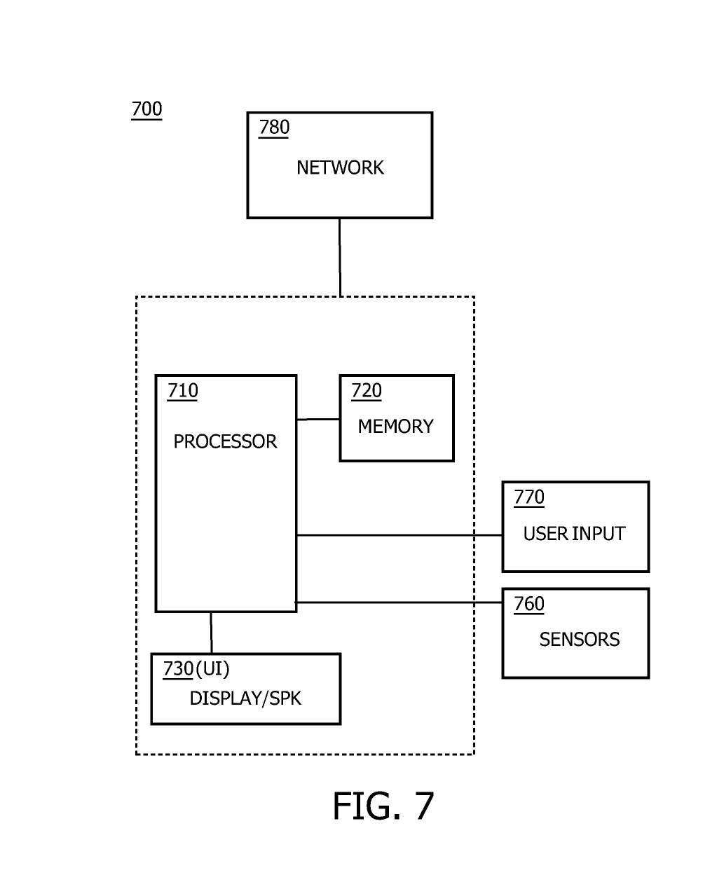

FIG. 7 shows a portion of a system in accordance with embodiments of the present system.

The following are descriptions of illustrative embodiments that when taken in conjunction with the following drawings will demonstrate the above noted features and advantages, as well as further ones. In the following description, for purposes of explanation rather than limitation, illustrative details are set forth such as architecture, interfaces, techniques, element attributes, etc. However, it will be apparent to those of ordinary skill in the art that other embodiments that depart from these details would still be understood to be within the scope of the appended claims. Moreover, for the purpose of clarity, detailed descriptions of well known devices, circuits, tools, techniques and methods are omitted so as not to obscure the description of the present system. It should be expressly understood that the drawings are included for illustrative purposes and do not represent the entire scope of the present system. In the accompanying drawings, like reference numbers in different drawings may designate similar elements.

FIG. 1 shows a flow diagram that illustrates a process 100 performed by an energy analysis system in accordance with embodiments of the present system. The process may determine where to place a limited number of sensors in order to acquire sufficient information in order to characterize the use and energy consumption of an entire building using, for example, energy extrapolation methods in accordance with embodiments of the present system. Once these sensors are in place, the process may acquire information from these sensors and may predict energy savings of potential ECMs for the building using energy extrapolation methods in accordance with embodiments of the present system. The process 100 may be performed using one or more computers communicating over a network and may obtain information and/or store information using one or more memories which may be local and/or remote from each other. The process 100 may include one of more of the following acts. Further, one or more of these acts may be combined and/or separated into sub-acts, if desired. Further, one or more of the acts of the process 100 may be performed sequentially or in parallel with one or more other acts of the process 100. In operation, the process may start during act 101 and then proceed to act 103.

During act 103, the process may obtain space attribute information (SAI) related to one or more desired attributes of one or more spaces in the building. For example, in some embodiments, the SAI may include information related to space identity (space (ID)), use type, square area, occupant density, and daylight (illumination) for a plurality of spaces in the building as will be discussed below. The SAI may be obtained automatically (e.g., in real time) from a memory of the system and/or from user inputs. For example, in some embodiments, the process may form and thereafter render a user interface (UI) with which a user may interact to input the SAI or portions thereof. For example, FIG. 2 shows a UI 200 rendered in accordance with embodiments of the present system.

Referring to FIG. 2, the UI 200 may include information specific to the building such as an address 202 or name (e.g., Omni Building) which may be input by the user and/or obtained from a memory of the system. Once a building has been identified, the SAI or other information related to the building may be obtained. The SAI may be obtained from the user (e.g., via the UI 200) and/or from a memory of the system. For example, the UI 200 may include a menu 220 in which a user may enter information (e.g., using a text entry box) and/or select information (e.g., using menu items such as menu selections, check boxes, radio boxes, etc.) related to the building or portions thereof. Accordingly, the UI may include information elements such as menu items related to space identifier information 204, use type identifier information 206, area information 208, occupant density information 210, and daylight information 212. This menu 220 may be formed in accordance with the SAI as will be discussed below. In some embodiments, the process may determine a current area based upon geo-location of a station of the user (e.g., a mobile station (MS) such as a smart phone, pad-style computer, etc., which may act as a display of the system and with which the user may interact to enter the SAI, if desired). A user may scroll through previous or next space using arrows (e.g., up/down) 216 and 218, respectively, to view information related to a corresponding space of the building. Further, the process may update the UI 200 in real time to reflect a user's selection. If it is determined that the user has selected the next space arrow 218, the system may associate the user-entered information with the corresponding space. The user may repeat this process for each space or for selected spaces of the building.

Referring back to the SAI, Table 1 illustrates SAI for a building in accordance with embodiments of the present system.

TABLE 1
Space Attribute Information (SAI)

| Space | | |
|---|---|---|
| Attribute | Choices (if | |
| (name) | discrete) | Definition |
| Space | variable | A numerical identifier such as a room |
| identifier | | number or sequential number |
| (Space ID) | | |
| Use type | 1 = office | A numerical categorization of space by |
| identifier | 2 = conference | use type (e.g. choices 1 = office, |
| (Use TypeID) | room | 2 = conference room, 3 = |
| | 3 = bathroom | bathroom, 4 = hallway, etc.) |
| | 4 = hallway | |
| Area | variable | The area of the space in square units |
| | | (e.g., m² in the present embodiments) |
| Occupant | variable | The occupant density (e.g., people/ |
| density | | square space units) (e.g., people/100 |
| (Occ. | | m²) |
| Density) | | |
| Daylight | 1 = low | A number on a numerical scale |
| | 2 = medium | (e.g. choices 1 = low, 2 = medium, |
| | 3 = high | 3 = high) indicating amount of |
| | | daylight in space |
| Lighting | variable | The lighting power density (W/m²) |
| power | | installed in the space |
| density (LPD) | | |
| . . . | | . . . |

Referring to the space attributes (SA) column of Table 1, the Space ID attribute may identify a space. For example, in some embodiments, the space ID may include a numerical identifier such as a room number or sequential number. As the Space ID is generally used for record keeping (e.g., to identify the space for later use) and not calculations, it may include any information which may identify the space and may be situated in any suitable alpha/numeric format. For example, in the present embodiments, the Space ID may include a numerical designation such as an integer which may have a different consecutive value for each space. However, in some embodiments, the Space ID may have a certain format such as floor no., room no., space number. For example, a second office space in room number three on the fifth floor may have a Space ID of 5 3 2. However, in yet other embodiments, the space number format may include information related to a floor number, a room number, an orientation (e.g., north side, south side, etc.). Regardless of format, the Space ID should be able to identify a space at a later time such as for installation of energy conservation measures (ECMs). The choices for each corresponding space attribute may be discrete (e.g., 1=office, 2=conference room, 3=bathroom, and 4=hallway; and 1=low, 2=medium, and 3=high for the use type identifier and daylight space attributes, respectively) which may define a discrete number of classes and may reduce user entry of data. This may increase user convenience as well as reduce input time.

With regard to the Use Type ID, this space attribute may include a discrete number of choices represented by numerical designations (or categorization) of space by use type (e.g., 1=office, 2=conference room, 3=bathroom, 4=hallway, etc.). The use type identifier may be a categorization of the space by use type (e.g., these may be referred to as use type categories) and has inherent in it expert knowledge of typical lighting schedules, occupancy schedules, energy consumption patterns and energy savings potentials. The use type categories may have corresponding energy savings potential, which can be determined in accordance with lighting schedules, occupancy schedules, etc. for each use type. Further, with regard to expert knowledge, this information may be stored in a memory of the system and may include information related to, for example, use type ID such as information related to typical lighting schedules, occupancy schedules, energy consumption patterns, energy savings potentials, etc. The choices numerical description (e.g., choices) of the Use Type ID may be set by the system and/or user and may depend on building type. For example, for hotels, the choices may include 1=office, 2=conference room, 3=bathroom, 4=hallway, 5=dining room, 6=main lobby, 7=shopping gallery, etc. In some embodiments, the process may request a user enter a type of building (e.g., office, mixed use, hotel, etc.) and the process may determine numerical values that are applicable for the current building. Further, it is envisioned that the process may correlate the numerical values so that information from different buildings may be analyzed.

With regard to the Area, this space attribute may identify a square footage of a corresponding area (e.g., in square units such as square meters (m²)). With regard to the Occupant density, this space attribute may include a value (e.g., estimated or actual) which may identify a number of people per square area such as people/100 m² in accordance with embodiments of the present system. With regard to the Daylight, this space attribute may include a discrete number of choices on a numerical scale (e.g. 1=low, 2=medium, 3=high) indicating an amount of daylight in the corresponding space (e.g., due to solar illumination (e.g., daylight or other external sources of illumination)). However, in yet other embodiments, other values may be provided. With regard to the LPD space attribute, this attribute may indicate the lighting power density (W/m²) installed in the corresponding space.

In some embodiments, a user may enter at least part of the SAI in response to requested inputs from a user interface (UI) generated by the process and rendered on a display of the system. For example, the system may request that a user enter SAI, or portions thereof, for a current space. However, in some embodiments, the process may determine an identification of a building (e.g., using location information such as address information, geographical coordinates (e.g., global position system (GPS)), etc.) and may obtain corresponding building information which may include, for example, SAI information, from a memory of the system. For example, in some embodiments, the process may obtain at least a portion of the SAI from technical documents (e.g., blueprints, layouts, previous energy surveys, etc.) related to the building and stored in a memory. Regardless, the SAI may characterize each space (or a given number of spaces) in a building. After completing act 103, the process may continue to act 105.

During act 105, the process may form an attribute vector (an) based upon the SAI. The attribute vector may characterize each (or selected) corresponding space of the plurality of spaces of the building. The attribute vector may have a column form corresponding with the SAI obtained during act 103 (e.g., see Table 1). Thus, the attribute vector may reflect a format of SAI and may change based upon the SAI. For example, assuming the SAI as per Table 1 is used, then the attribute vector may have a format of:

$$\overline{{a}_{n}} = [ \begin{matrix}Space ID \\ Use Type ID \\ Area \\ Occ . \\ Density \\ Daylight\end{matrix} ] \qquad Eq . ( 1 A )$$

Thus, assuming the building has a plurality of spaces (e.g., 1-N as will be discussed below) each identified by corresponding attribute vector a₁ and that a first space is identified as room number 101 and is an office area of 100 m² with an occupant density of 5 persons/100 m², a high level of daylight illumination and an installed LPD of 10.76 W/m², the process may form a corresponding attribute vector a₁ in column form:

$$\vec{{a}_{1}} = [ \begin{matrix}101 \\ 1 \\ 100 \\ 5 \\ 3 \\ 10.76\end{matrix} ] . \qquad Eq . ( 1 B )$$

Thus, the process may form an attribute vector for each space or selected spaces of the building. In some embodiments, it is envisioned that the attribute vector may be formed in row form. After completing act 105, the process may continue to act 107.

During act 107, the process may characterize the building using a matrix B formed by the process and which may include the attribute vectors (e.g., a₁, through aₙ for each space of the building. Thus, B may be represented as:

B=[\vec{a₁} . . . \vec{aₙ}], Eq. (2)

where B is a row vector with n columns each corresponding to one of N spaces in the building B. With regard to n, this value may be an integer index having a range of 1 through N.

Generally, acts 105 and 107 may be considered acts which characterize building space by attribute vectors and, therefore, may be considered space attribute characterization acts. After completing act 107, the process may continue to act 109.

During act 109, the process may cluster the spaces of the building into classes. The spaces may be clustered in accordance with their energy consumption and energy savings potentials. Assuming, a group of spaces includes all the spaces of the building. Then, the clustering may place each of the spaces of the building into one or more subgroups in accordance with their energy consumption and energy savings potential. Accordingly, all the spaces that are clustered in a subgroup should have similar energy consumption and energy savings potential. In other words, the clustering may form one or more subgroups of spaces each including one or more of the spaces from the group of spaces. Further, each of the groups or subgroups may form or otherwise be associated with a corresponding class of a plurality of classes as will be discussed below.

To cluster, the process may determine a classification of space types by energy consumption and energy savings potential. This may be known as a space-energy type classification and the process may form corresponding space-energy type classification information. Given that all the spaces in the building B are represented by corresponding attribute vectors \vec{a₁} . . . \vec{aₙ}, the process may cluster these spaces (e.g., by performing a space-energy type classification) into classes where each class is chosen to distinguish spaces by energy consumption and energy savings potential (or other desired attributes as may be selected by the system and/or user). Thus, within each class (e.g., of q classes as may be selected by the user and/or system, where j may be set as an index. For example, in the present embodiments j may be an integer from 1 through q), each space (e.g., in that class Cⱼ) may be expected to perform similarly with respect to energy consumption and energy savings from energy conservation measures (ECMs) employed upon that class Cⱼ. To do this, the process may generate a classifier (\vec{d_{C}_{ⱼ}}) which is a function of the corresponding attributes (e.g., of the corresponding attribute vector aₙ) and which serves to generate a score (e.g., a classification score) that indicates an appropriateness of the classification for that set of attributes. In some embodiments, the classifier may be a linear classifier that is applied to the attribute (column) to generate a classification score (also score) represented by:

score(\vec{aᵢ},Cⱼ)=\vec{d_{C}_{ⱼ}}·\vec{a₁}. Eq. (3)

In some embodiments, the classifier \vec{d_{C}_{ⱼ}} may be a linear classifier that is applied to the corresponding attribute vector aₙ. Here, the classifier \vec{d_{C}_{ⱼ}} is a row vector of weights defined for each class Cⱼ, and, when dotted with the attribute vector (e.g., \vec{a₁} in the current example), results in a scalar value (e.g., a score) that is used to determine how well the space characterized by the corresponding attribute vector (e.g., \vec{a₁} in the current example) fits into a class Cⱼ. Thus, the process may generate a plurality of scalar values known as classification scores that determine how well each space is characterized by its corresponding attribute vector. Thus, for each of the classes C₁ . . . C_{q}, classifiers \vec{d_{C}_{₁}} . . . {right arrow over (d_{C}_{_{q}})} are applied to B, to generate classification scores for each corresponding class C₁ . . . C_{q} as it relates to each space of the plurality of spaces of the building. Then each space is assigned to a single class Cⱼ based upon its classification scores.

For example, in the present embodiment, assuming there are 20 classes C₁ . . . C_{q}), these classes will each be applied to each attribute vector aₙ of B and corresponding classification scores may be determined by the process. Then, the process may select a class Cⱼ with the highest score from the classes C₁ . . . C_{q} (e.g., indicating a best fit) for the corresponding attribute vector an of B. Accordingly, this attribute vector aₙ of B may then assigned to the corresponding class cᵢ which is determined to be a best fit from all the classes C₁ . . . C_{q}. Accordingly, each of the attribute vectors aₙ of B may be assigned to a (single) class cᵢ of the classes C₁ . . . C_{q} which best fits the corresponding attribute vector aₙ of B. Further, one or more of the classes cᵢ of the classes C₁ . . . C_{q} may have one or more attribute vectors aₙ of B assigned thereto. Further, one or more of the classes cᵢ of the classes C₁ . . . C_{q} may have no attribute vectors aₙ of B assigned thereto. The above-described clustering example, is better illustrated with reference to a single attribute vector a₁ of B which has the following classification scores as illustrated in Table 2 below for 5 classes cᵢ.

TABLE 2
Attribute for α₁ of B

| | Classification |
|---|---|
| Class cᵢ | Score |
| C₁ | 20 |
| C₂ | 35 |
| C₃ | 15 |
| C₄ | 21 |
| C₅ | 34 |

With reference to Table 2, class c₂ of the classes C₁ . . . C_{q} may have a highest score, accordingly, the process may assign the attribute vector a₁ of B to class c₂ of the classes C₁ . . . C_{q}.

Thus, all the spaces of the building B may be clustered into corresponding classes cᵢ each representing a certain energy consumption and energy savings behavior (or potentials). After completing at 109, the process may continue to act 111.

During act 111, the process may perform a class attribute characterization in which the process forms one or more class attribute vectors (CAVs) e_{c1} . . . e_{cj} each of which represents the aggregate attributes of a corresponding class cⱼ of the classes C₁ . . . C_{q} in vector form as a CAV.

For example, assuming a class cᵢ has the class attributes shown in Table 3 below.

TABLE 3

| Class Attributes for Class cᵢ | Definition |
|---|---|
| Class identifier (Class ID) | A numerical identifier such as a sequential number (not used for |
| | calculations) |
| Use type identifier (Use | A numerical categorization of space by use type (e.g. 1 = office, 2 = |
| TypeID) | conference room, 3 = bathroom, 4 = hallway, etc.) |
| Area | The aggregate area of all the spaces in the class (e.g., in square |
| | meters) |
| Occupant density (Occ. | The mean occupant density of all the spaces in the class (e.g., |
| Density) | people/100 m²) |
| Daylight | The mean of the daylight numerical scale (e.g. 1 = low, 2 = |
| | medium, 3 = high) for all the spaces in the class |
| Lighting power density(LPD) | The mean lighting power density (W/m²) of all the spaces in the |
| | class |
| Frequency | The total number of spaces in the class |
| Energy Savings Potential for | A numerical categorization of energy savings potential (e.g. 1 = |
| ECMᵢ | low, 2 = medium, 3 = high) for a given ECMᵢ. |

With regard to the energy savings potential for ECM, this may be determined by the system and/or by user. For example, in accordance with some embodiments, the energy savings potential may be determined in accordance with expert knowledge stored in a memory of the system and may be determined using any suitable application for determining energy savings potential. However, in yet other embodiments, the energy savings potential may be set by the user and/or stored in a memory of the system for later use. Thus, in accordance with some embodiments, given class attributes, for each ECM, the energy savings potential can be determined through various means, e.g., hand calculations, simulation, etc.

Then, for each class cᵢ of the classes C₁ . . . C_{q} a corresponding CAV e_{cj} may formed and may be based upon the class attributes of the corresponding class cᵢ of the classes C₁ . . . C_{q}. For example, assuming the class cᵢ has the class attributes shown in Table 3 above, the attribute vector e_{cj} may be defined as:

$$\overline{{e}_{cj}} = [ \begin{matrix}Class ID \\ \begin{matrix}Use Type ID \\ Area \\ Occ . \\ Density \\ Daylight\end{matrix} \\ LPD \\ Frequency \\ FCMi\end{matrix} ] \qquad Eq . ( 4 )$$

For example, for an arbitrary class c₁, a corresponding CAV \vec{e_{C}_{ᵢ}} may have the following values:

$$\vec{{e}_{{c}_{1}}} = [ \begin{matrix}1 \\ 1 \\ 10000 \\ 5.5 \\ 3 \\ 10.1 \\ 20 \\ 3\end{matrix} ] \qquad Eq . ( 5 )$$

where: the class identifier (Class ID)=1; use type (Use Type ID)=office; total area (Area)=10,000 m²; mean occupant density (Density)=5.5 people/100 m²; mean daylight index (Daylight)=3; mean LPD (LPD)=10.1 W/m²; frequency (e.g., total number of spaces in class) (Frequency)=20; and energy savings index (ECMi)=3. After completing act 111, the process may continue to act 113.

During act 113, the process may determine priority for each class cⱼ of the classes C₁ . . . C_{q}. Generally, the priority p_{cj} may be a function of (e.g., based upon) the class attributes and may be determined by the system as described below. The priority p_{cj} may be a scalar which is a linear combination of class attributes (e.g., of the CAV e_{cj}) which are weighed by a weighting vector \vec{k}. The weighing vector \vec{k} may have the same dimensions as the attribute vector \vec{e_{C}_{₁}}. Accordingly, if the attribute vector \vec{e_{C}_{₁}} has dimension of eight (as in the present example), the weighting vector \vec{k} will have a dimension of eight. The weighing vector \vec{k} may be defined as:

\vec{k}=[k₁ . . . k₈] Eq. (6)

With regard to values of the weighing vector \vec{k} in accordance with some embodiments values of \vec{k}, may be set by the system and/or user in accordance with criteria which may be considered important. For example, referring to Eq (4) and assuming the Area, Frequency, and Energy Savings Potential (e.g., ECMi) are considered to be most important criteria for selecting the sensor placement, the system may set values of k₃, k₇, and k₈ to nonzero values (e.g., 1), and all other values of k (e.g., k₁, k₂, k₄, k₅, and k₆, in the preset embodiments) may be set equal to zero. Further, in accordance with some embodiments, it is envisioned that the specific nonzero values of k₃, k₇, and k₈ may be determined by the system such that a resulting priority scalar may be set to a reasonable value. However, in some embodiments the priority scalar does not need to be a linear combination of scaled values. For example, in some embodiments, functions may be used to determine the priority.

Then, the resulting priority p_{C}_{₁} for the first class c₁ may be calculated and represented as a scalar where a higher value indicates a higher priority for sensors to be installed in spaces belonging to a corresponding class cⱼ of the classes C₁ . . . C_{q}. Thus, for class c₁ the resulting priority p_{cj} may be represented as:

p_{C}_{₁}=\vec{k}·\vec{e_{C}_{₁}} Eq. (7)

The process may do this for each class cⱼ. In this case, k₁ through k₈ are chosen to weight each attribute appropriately in determining priority p_{cj}

Then, extending to all classes cⱼ,

\vec{P}=\vec{k}·[\vec{e_{C}_{₁}} . . . {right arrow over (e_{C}_{_{q}})}] Eq. (8)

\vec{P}=[p₁ . . . p_{q}], Eq. (9)

where \vec{P} is the priority vector containing the priority scalars p₁ . . . p_{q} for each of the classes cⱼ. Accordingly, each of the classes C₁ . . . C_{q} may then be assigned a priority p₁ . . . p_{q}, respectively. Thus, class c₁ may be assigned a priority of p_{c1}; class c₂ may be assigned a priority of p_{c2}; and class cⱼ may be assigned a priority of p_{cj}. After completing act 113, the process may continue to act 115.

During act 115, the process may assign sensors using a sensor assignment method which assign sensors to classes cⱼ of the classes C₁ . . . C_{q} in accordance with its corresponding priority and/or under a constraint of a total number of sensors represented by X. Generally, the sensor assignment may be a function of the determined priorities for each of the classes C₁ . . . C_{q}. In some embodiments, the sensors may be assigned to classes in direct proportion to the determined priorities for each of the classes C₁ . . . C_{q}. For this approach, a scale factor m may be calculated based on the total number of sensors X and the summation of all priority scalars (e.g., p₁ through p_{q}). Thus, the scale factor m may be represented as:

$$scale factor m = \frac{x}{{\sum }_{i = 1}^{q} {p}_{i}} \\ where X = total number of sensors \qquad Eq . ( 10 )$$

Then the sensor assignment vector S may be represented as a scaled priority vector:

\vec{S}=m·\vec{P} Eq. (11)

\vec{S}=[s₁ . . . s_{q}] Eq. (12)

where s₁ through S_{q} represent the number of sensors to be respectively assigned to spaces in classes C₁ through C_{q}. Thus, if s₁=5, the process will assign class C₁ 5 sensors from the total number of sensors X. Further, the process may perform a rounding process to the nearest integer if it is determined that any of s₁ through s_{q} contains a fraction. Further, this rounding process may be performed in accordance with rounding rules such that the total number of sensors assigned to all classes does not exceed the total number of sensors X. Thus, in some embodiments, the process may round up and in some the process may round down so that the number of assigned sensors is not greater than the total number of sensors X. After completing act 115, the process may continue to act 117. The sensors may be placed in each class randomly or using a predetermined method, if desired.

During act 117, the process may determine sensor placement in accordance with the sensor assignment vector S determined above and thereafter, the sensors are installed in the building spaces. Further, given that a certain number of sensors sᵢ need to be placed in spaces of class Cᵢ as determine by the sensor assignment vector S, these assigned sensors may be distributed randomly (e.g., using a random assignment method) to the spaces within their assigned class Cᵢ by the process. This assignment may be referred to as a sensor assignment and may generate corresponding sensor assignment information.

Further, the process may generate blueprints and/or tables for sensor placement and sensor identification in accordance with the sensor assignment information. For example, the process may generate a table indicating class Cⱼ, a total number of sensors assigned to the class c and/or spaces assigned to the class cⱼ of classes C₁ . . . C_{q}. This may be represented as shown in Table 4 below and may be rendered on a display of the system for the convenience of the user or stored for future use. For the sake of clarity, classes cⱼ and/or spaces which are not assigned sensors sᵢ are not shown.

TABLE 4

| Class | No. Sensors | |
|---|---|---|
| (assigned) | (total X = 20) | Space ID |
| C₁ | 15 | 101 |
| | | 102 |
| C₂ | 5 | 104 |
| | | 108 |
| | | 110 |

In accordance with embodiments of the present system, the sensors may include smart sensors such as Philips™ OccuSwitch Logger™ sensors or the like, which may detect information related to environmental conditions in the corresponding area such as occupancy (e.g., determined using any suitable method such as a passive infra-red (IR) sensor which may detect motion, the presence of a individual, etc., a light beam (e.g., which may be broken when an individual passes through the beam, a floor-based sensor (e.g., activated by a user's weight placed on the sensor, etc.), switch status (e.g., on/off/dim), light levels (e.g., illumination due to ambient sources such as sunlight, external sources, etc.), etc., and form corresponding sensor information which may be provided to a controller of the system for further use and/or stored in a memory of the system for later use. The sensor information may further include information which may identify the sensor sending the information such as sensor identification (ID) information, sensor class information (e.g., class cⱼ), and/or location information (e.g., space ID), which may identify a sensor, its class, and/or location, respectively. In some embodiments, the sensor information may be used to estimate energy savings, etc. The sensor information may be used to at least partially calculate energy savings. After completing act 117, the process may continue to act 119.

During act 119, the process may acquire the sensor information and analyze the sensor information to determine information such as occupancy (e.g., motion detected), electric light switch status (e.g., on/off/dimming level), and/or daylight level.

In some embodiments, the sensor acquisition process may be passive or active. For example, in some embodiments, the sensors may push information to the controller while in other embodiments, the sensors may respond to a query of the controller for information by transmitting query results to the controller. After completing act 119, the process may continue to act 121.

During act 121, the process may predict energy savings for various energy conservation measures (ECMs) for the building based upon results of an analysis of the sensor information. For example, the process may analyze the sensor information and predict energy savings such as, occupancy-based switching of lights, and daylight dimming which may be employed by the process, or parts thereof, to reduce energy consumption in the building. The process may further determine for each installed sensor the following information: (A) a baseline energy consumption (Base); (B) energy savings from occupancy-based switching (ECM₁); (C) energy savings from daylight dimming (ECM₂); and/or (D) energy savings from occupancy-based switching and daylight dimming (ECM₃). Methods to determine this information is discussed in U.S. Patent Application Ser. No. 61/840,546, filed Jun. 28, 2013, the entire contents of which is incorporated herein by reference thereto. After completing act 121, the process may continue to act 123.

During act 123, the process may perform an energy extrapolation process in which sensor-based energy savings analysis (e.g., of act 121) may be extrapolated to the whole building. The process may further form a corresponding energy extrapolation vector (energy extrapolation). To perform the energy extrapolation, the process may determine a baseline energy use (e.g., current energy use) for each sensor of the plurality of sensors (e.g., the X sensors in the current example). In accordance with some embodiments, sensor information may be used to estimate a baseline energy use and corresponding ECM energy use. Sensor information for each class (cⱼ) may be averaged in order to determine an energy use intensity for the corresponding class (cⱼ). For example, energy use may be determined for each sensor assigned to each corresponding class cⱼ. Thereafter energy savings estimates may be determined for one or more ECMs for the corresponding class cⱼ.

In accordance with some embodiments, sensor data may be aggregated by an energy calculation application of the present system that may determine baseline and/or ECM energy consumption for each sensor. The energy calculation application may then extrapolate the baseline and ECM energy consumptions for each sensor to the whole building using any suitable method such as by essentially reversing the sensor assignment process. Thereafter, the process may use the energy savings estimates for each of the one or more ECMs to extrapolate results to the entire building or to subsets of spaces of the building where the ECMs will be installed. With regard to determining where the ECMs may be installed, in accordance with some embodiments, ECMs such as daylight dimming may be installed within areas of the building which have windows and, subsequently are illuminated by daylight. Accordingly, in some embodiments the process may consider subsets of spaces in a building for determining types of ECS as opposed to the entire building by default.

With regard to the extrapolation process, this process is primarily driven by the classification as the classification is performed based on energy consumption and energy savings potential behavior. For example, for a given class Cᵢ that has sᵢ number of sensors installed in various spaces belonging to (e.g., assigned to) Cᵢ, the baseline energy use and energy savings per area may be determined. Then, results of the baseline energy use of all sensors installed in one class cⱼ may be averaged to give a mean Energy Use Density (EUD_{C}_{ᵢ} (e.g., in kWh/m²)) and/or a mean Energy Savings Density (ESD_{C}_{ᵢ} (e.g., in kWh/m²)) for that class for a given ECM and/or baseline energy use. The process may do this for each class cⱼ of all the classes (or each class cⱼ which is assigned sensors).

This process may be performed for all the sensors which will result in an EUD and an ESD for each of the sampled classes in the building for a specific ECM or baseline. For example:

$$\begin{matrix}{EUD}_{{Base}_{{C}_{1}}} … {EUD}_{{Base}_{{C}_{q}}} ( energy use densities for baseline , all classes ) & Eq . ( 13 ) \\ {ESD}_{ECM {1}_{{C}_{1}}} … {ESD}_{ECM {1}_{{C}_{q}}} ( energy savings densities for ECM 1 , all classes ) & Eq . ( 14 )\end{matrix}$$

Extrapolating to the entire building may then be performed by multiplying the densities (e.g., the EUDs and ESDs shown above in Eqs. 13 and 14) by the corresponding total area of each class cⱼ of the classes C₁ . . . C_{q}. and then summing results from all classes cⱼ. This will result in a total energy consumption (or savings) in kWh for the building (or subset of building, if desired, for calculations).

$$\begin{matrix}Baseline Energy Consumption = {Σ}_{i = 1}^{q} {EUD}_{{Base}_{{C}_{i}}} \times {TotalArea}_{{C}_{i}} & Eq . ( 15 ) \\ Energy Savings ECM 1 = {Σ}_{i = 1}^{q} {ESD}_{ECM {1}_{{C}_{i}}} \times {TotalArea}_{{C}_{i}} & Eq . ( 16 ) \\ Energy Savings ECM 2 = {Σ}_{i = 1}^{q} {ESD}_{ECM {2}_{{C}_{i}}} \times {TotalArea}_{{C}_{i}} & Eq . ( 17 )\end{matrix}$$

The process may then perform these calculations for each envisioned ECM. The process may further rank the results of the ECMs and determine a highest ranking ECM of the ECMs. This highest ranking ECM may be expected to provide the greatest energy savings of all the ECMs. Further, the process may determine energy analysis information such as ECM2 is the most cost and energy effective and is expected to save Z watts/m² per unit time and at current electrical rates this may result in savings of Y dollars/unit time. After completing act 123, the process may continue to act 125.

During act 125, the process may render results of the process for the convenience of the user. Accordingly, the process may generate a user interface (UI) which may include results of the process to be rendered and/or a menu system in which the user may interact with the system to obtain further analysis and/or to tweak the results. The UI may then be rendered on, for example, a display of the system for the convenience of the user. For example, FIG. 3 shows a user interface 300 including results of the process and rendered on a display of the system in accordance with embodiments of the present system. The results may include a menu 302 including information such as the baseline energy consumption 304, expected energy savings for each ECM, ranking of the ECMs (e.g., “ECM 2 is the most cost and energy efficient and is expected to save Z watts/m² per unit time and at current electrical rates this may result in savings of Y dollars/unit time.”) The process may further provide an estimate of implementation cost for each ECM, if desired. Moreover, the process may determine a time period during which the initial costs to implement the ECM are expected to be returned due to cost savings of the corresponding ECM. This information may be displayed as “return on initial investment=two weeks.” In yet other embodiments, the process may determine implementation cost differences between ECMs and render this information for the convenience of the user on a display of the system. After completing act 125, the process may continue to act 127.

During act 127, the process may form and/or update building history information in accordance with results of the process and/or any user inputs (e.g., during act 125). The building history information may be stored in a memory of the system for later use. After completing act 127, the process may continue to act 129, where the process ends.

Thus, process 100 includes three basic steps each of which may include substeps as shown in Table 4 below.

TABLE 4

| Step | Acts | |
|---|---|---|
| 1 | Determine where in the building to place sensors (sensor | |
| | placement procedure) | |
| | a. | Characterizing building spaces by attribute vectors |
| | | (e.g., space attribute characterization); |
| | b. | Classification of space types by energy consumption |
| | | and energy savings potential (e.g., space energy type |
| | | classification); and |
| | c. | Generating priority and assignment of sensors (e.g., |
| | | (class attribute characterization) (priority assignment) |
| | | (sensor assignment)) |

| | |
|---|---|
| 2 | Acquire data from installed sensors, process/analyze data |
| 3 | Extrapolate sensor-based analysis to entire building |
| | (energy extrapolation) |

Decoupling Spaces

A process to decouple spaces into space types and then derive the resulting energy use indexes (ails) to determine energy use and/or energy savings is provided in accordance with embodiments of the present system.

During this process, spaces in a building may be decoupled into building related (BR) and use type (UT) space types, then, EUIs for each of the first and second space types may be determined (e.g., by simulation) by embodiments of the present system. This process is explained with respect to FIG. 4 which shows a flow diagram that illustrates a process 400 performed by an energy analysis system in accordance with embodiments of the present system. The process 400 may be performed using one or more computers communicating over a network and may obtain information and/or store information using one or more memories which may be local and/or remote from each other. The process 400 may include one of more of the following acts. Further, one or more of these acts may be combined and/or separated into sub-acts, if desired. Further, one or more of the acts of the process 400 may be performed sequentially or in parallel with one or more other acts of the process 400. In operation, the process may start during act 401 and then proceed to act 403.

During act 403, the process may obtain space-type decoupling information (STI) which may include building-related (BR) decoupling information and use-related (UR) decoupling information. However, in yet other embodiments, other type of information are also envisioned and may be defined by the system and/or user. The BR decoupling information focuses on differentiating space types based upon their exposure to an exterior environment (e.g., ambient conditions) or lack thereof (e.g., interior space). For example, illustrative space-type attributes for the BR decoupling information in accordance with embodiments of the present system are defined in Table 5 below.

TABLE 5
Building-Related Space-Type Decoupling

| Space-Type Attribute | Choices | Definition of Space Type Attribute |
|---|---|---|
| Perimeter zone and | North (N), | Orientation of perimeter zone such as N, S, E, W, NE, NW, |
| orientation | South (S), | SE, and SW or combinations thereof. |
| | East (E), | Differences in exposure to sun and the resulting solar gains |
| | West (W), | requires a decoupling of space types by orientation (i.e. |
| | AND | North, South, East, West facing, additionally NE, NW, SE, |
| | OPTIONALLY: | SW may be considered as well in some embodiments). |
| | NE, | This is particularly true for perimeter zones with windows. |
| | NW, | This accounts for weather exposed vertical or |
| | SE, and | substantially vertical perimeter building surfaces. |
| | SW | In other words, perimeter zones have N, S, E, W, N, NW, SE, |
| | | and/or SW facing perimeter walls or windows. |
| Core zone | Core | A core zone has no vertical surfaces exposed to weather. |
| | | In other words, a core zone does not have any exterior |
| | | walls or windows. |
| Floor | Ground Floor | The coupling of horizontal building surfaces (e.g., floors or |
| | Middle Floor | ceiling) is critical to the energy performance of the |
| | Top Floor | building space. |
| | Single Floor | Space types may be differentiated by floor: ground floor |
| | | (floor with thermal coupling to ground, ceiling coupled to |
| | | other zone of similar temperature), middle floor (floor and |
| | | ceiling coupling to other zones of similar temperature), |
| | | top floor (floor coupled to other zone of similar |
| | | temperature, roof with thermal coupling to exterior |
| | | environment), single floor (with floor coupled to ground, |
| | | and roof coupled to exterior environment). |
| Window | Window Wall | Window size is critical to the performance of the building |
| | Ratio (WWR) | envelope and is typically expressed as a window to wall |
| | | ratio (WWR), which is the percentage of the area of a |
| | | building vertical surface that is window area. |
| Glazing | Glazing | The window glazing performance (optical and thermal) is |
| | | another parameter used to estimate transmission of |
| | | visible light (for daylight-based lighting controls) and solar |
| | | gains. The glazing may have a plurality of types (e.g., 1-10) |
| | | with ten indicating most efficient windows and 1 least |
| | | efficient). |

In contrast to the BR decoupling information, the UR decoupling information focuses on differentiating space types by how they are used by the occupant(s) of the building B. Ultimately, use will determine the internal thermal gains (e.g., due to power use, etc.) in a space of the building. For example, use may include occupancy, lighting, and electrical plug loads. For example, the key use types for commercial office buildings may include single person office, open plan office, common area, conference room, bathroom, etc. The key use types for hospitals may include single person room, double occupancy room, common area, recovery room, surgical room, bathroom, etc. In some embodiments the space attribute information of the process 100 may be substituted in whole or in part with the space-type attribute information or vice versa.

In accordance with yet other embodiments of the present system, the key space types for a building-related decoupling process may be defined as illustratively shown in Table 6 below, which includes a definition of space-type attributes and corresponding choices for the BR and UR STI.

TABLE 6
Building-Related Space-Type Decoupling (Building Classification = Office Building)

| Space-Type | | |
|---|---|---|
| Attribute | Choices | Definition of Space Type Attribute |
| Floor | 1: Ground Floor | The coupling of horizontal building surfaces (e.g., floors or |
| | 2: Middle Floor | ceiling) is significant to the energy performance of the |
| | 3: Top Floor | building space. |
| | 4: Single Floor | Space types may be differentiated by floor: ground floor |
| | | (floor with thermal coupling to ground, ceiling coupled to |
| | | other zone of similar temperature), middle floor (floor and |
| | | ceiling coupling to other zones of similar temperature), |
| | | top floor (floor coupled to other zone of similar |
| | | temperature, roof with thermal coupling to exterior |
| | | environment), single floor (with floor coupled to ground, |
| | | and roof coupled to exterior environment). |
| Zone Type | 1: Core | Orientation of perimeter zone such as N, S, E, W, NE, NW, |
| | 2: Perimeter-(N) | SE, and SW or combinations thereof. |
| | 3: Perimeter (S) | Differences in exposure to sun and the resulting solar gains |
| | 4: Perimeter (E) | requires a decoupling of space types by orientation (i.e. |
| | 5: Perimeter (W) | North, South, East, West facing, additionally NE, NW, SE, |
| | | SW may be considered as well in some embodiments). |
| | | This is particularly true for perimeter zones with windows. |
| | | This accounts for weather exposed vertical or |
| | | substantially vertical perimeter building surfaces. |
| | | In other words, perimeter zones have N, S, E, W, N, NW, SE, |
| | | and/or SW facing perimeter walls or windows. |
| | | A core zone has no vertical surfaces exposed to weather. |
| | | In other words, a core zone does not have any exterior |
| | | walls or windows. |
| Window/Wall | 1: 33% | Window size is significant to the performance of the |
| Ratio (WWR) | 2: 66% | building envelope and is typically expressed as a window |
| | | to wall ratio (WWR), which is the percentage of the area |
| | | of a building vertical surface that is window area. |
| Glazing | 1: clear glass | The window glazing performance (optical and thermal) is |
| | 2: tinted glass | another significant parameter to estimate transmission of |
| | | visible light (for daylight-based lighting controls) and solar |
| | | gains. |
| Use Type | 1: single person | The use type defines how the space is used which is a |
| | office | primary driver of the energy consumption. The use type |
| | 2: open plan | will determine parameters such as occupancy schedules, |
| | office | lighting schedules, thermostat schedules, etc. |
| | 3: common area | |
| | 4: conference | |
| | room | |
| | 5: bathroom | |
| ECM type | 1: base case | Base energy use or usage and |
| | 2: ECM1 | Desired energy conservation modes (ECM) types (e.g., |
| | 3: ECM2 | ECM 1 through ECM 3) |
| | 4: ECM3 | |

With regard to square footage of a space, in some embodiments, simulation models with appropriate square footages may be determined for each of the decoupled space types, and simulations to determine the energy use intensities may then be performed by the system.

The process may acquire the STI including the BR and/or UR space-type information from the user, by, for example, forming and thereafter rendering a user interface (UI) with which a user may interact to input the STI. For example, FIG. 5 shows a UI 500 rendered in accordance with embodiments of the present system. The UI 500 may include information specific to a current building B such as address information 520 which may be input by the user and/or obtained from a memory of the system. Accordingly, a user may, for example, enter an address or a building name (e.g., “ABC Building”) and the process may obtain information related to the building B such as STI from the user (e.g., via the UI 500) and/or from a memory of the system. For example, the UI 500 may include a menu 502 formed in accordance with the STI of Table 6 (e.g., column 2). Once rendered, the user may interact with the user interface 500 to input (e.g., enter) and/or select information related to the STI such as values for space identification (ID) information 518; floor information 504; zone type information 506; WWR information 508; glazing information 510; use type information 512; and ECM type information 514. Referring to Table 6, the STI attributes may act as key parameters for the space-type decoupling to be performed by embodiments of the present system and may define the size (e.g., based upon the choices for each attribute) of the simulation space required for determining all possible EUIs for the EUI database. In accordance with some embodiments, EUIs may be generated for all, or substantially all, possible combinations of the space type attributes and may thereafter be stored in a memory of the system such as in an EUI database, indexed by the corresponding attributes. Accordingly, a query of the EUI database may be performed by providing attributes such as the six attributes, e.g. Floor=middle, Zone type=perimeter South, WWR=33%, Glazing=clear, Use Type=single person office, ECM=daylight dimming, and the database will return the appropriate EUI or EUIs. Separate EUIs may be provided for lighting, heating, and cooling.

Referring back to FIG. 5, the user may enter information using the UI 500 for each space of a plurality of spaces of the building B. The user may select arrow 516 to continue to associate the current STI information with the current space (e.g., A01) and store this information in a memory of the system.

Referring to Tables 3, 4A and 4B, other embodiments of STI attributes may be developed (e.g., by the user and/or system) for buildings having classifications such as educational institutions, hospitals, etc. For example, in some embodiments, each building classification (e.g., office, hospital, factory, warehouse, may have corresponding space type information stored in a memory of the system and which may be accessed in accordance with a current building's classification. For example, if it is determined that the current building is classified as an office building, the STI attributes for a commercial office building may be obtained from a memory of the system. However, if it is determined that the current building is classified as a hospital, the STI attributes for a hospital may be obtained from a memory of the system. Thus, embodiments of the present system may determine a building's classification type, determine corresponding STI attributes and form a corresponding user interface (UI) which may rendered by the system (e.g., on a display, etc.) and with which the user may enter desired space type information. In accordance with embodiments of the present system, each attribute may have one or more discrete choices. For example, referring to the Floor space-attribute, there may be four discrete choices. The zone type space-type attribute may have five discrete choices.

The process may repeat act 403 for each space of the plurality of spaces of the building (B). Further, in some embodiments a space identifier (ID) 518 (e.g., A01 in the current example) may be automatically determined (e.g., in alpha numeric order and/or by tracking a station of the user using a location application). However, in yet other embodiments, the space ID 518 may be input directly by the user. After completing act 403, the process may continue to act 405. Further, in some embodiments, it is envisioned that only when it is determined that STI was entered for each space in the building, the process may continue to act 405. However, if it is determined that the user has not entered space STI for each space in the building, the process may continue to render a UI such as the UI 500 to enter the STI. Further, the process may inform the user that STI of one or more spaces in the building has not been entered. The process may further offer a user an option to select to indicate that STI for all relevant spaces in the building for which STI is to be entered has been completed and the process may then continue to act 405.

During act 405, the process may determine specific occupancy, lighting, and/or plug (electrical) load profiles for the STI obtained during act 403. The specific occupancy, lighting, and/or plug load profiles may be necessary for direct energy consumption calculations and/or internal gain calculations for thermal loads in the corresponding space and may be obtained from a memory of the system. For example, each space type attribute selection may have an associated specific occupancy, lighting, and/or plug load profile stored in a memory of the system. For example, a specific occupancy, lighting, and/or plug load profile for a single person office may be 1 (person), 160 (watts), and, 500 (watts), respectively, while for a double occupancy office the profile may be 2 (persons), 160 (watts), and 1200 (watts), respectively.

In accordance with some embodiments of the present system, an occupancy profile (or schedule) may specify for all times of day (e.g. hourly) and all days of week the number of occupants in the space. A metabolic activity level when the person is present, e.g., for office work 100 W or so, may be assumed by the system. However, in yet other embodiments, a separate schedule for metabolic activity may be used and may be determined by the system and/or user. The lighting schedule may specify for all times of day and all days of week the power level for the lights in a corresponding space. After completing act 405, the process may continue to act 407.

During act 407, the process may run one or more simulations to build model EUIs which may represent all possible space types (e.g., all possible combinations of the space type information settings). and ECMs for the building. In the present embodiments, simulations may include, for example: (A) a base case: no ECMs employed (e.g. manually switched lights); (B) a first ECM (ECM1): occupancy-based switching of lights; (C) a second ECM (ECM2): occupancy-based switching of lights and daylight harvesting; and (D) a third ECM (ECM3): thermostat set-point scheduling (e.g., a night-time setback). These ECM setting combinations are shown in Table 7 below which is an ECM settings table and which may be stored in a memory of the system for later use. Referring to Table 7, the ECM settings may include other ECM case types (e.g., modes) as may be determined by the user and/or system and stored in a memory of the system for later use. When running the one or more simulations to build models, the system may acquire the simulation models from the ECM settings of Table 7.

TABLE 7
ECM Table (Simulation Models)

| EUI | | | | Thermostatic | |
|---|---|---|---|---|---|
| Case | Manual | Occupancy-Based | Daylight | Set Point | |
| Type | Switching | Switching | Harvesting | Scheduling | Other |
| Base | x | | | | |
| ECM1 | | x | | | |
| ECM2 | | x | x | | |
| ECM3 | | | | x | |

Referring back to the space-type attributes of Table 6, for each combination of space-type attribute settings, a simple model may be developed and simulated using any suitable building simulation tool such as EnergyPlus™ which may be configured in accordance with embodiments of the present system. For these discrete choices, there are 1600 total possible combinations and thus 1600 simulation cases must be run to calculate the 1600 EUIs. Furthermore, this set of 1600 EUIs is determined for one geographical location. This geographical location (e.g., which determines weather conditions) may include all or a portion (e.g., a fragment) of a building or buildings which may be simulated by embodiments of the present system. Additional geographical locations will require simulating all 1600 cases for each additional geographical location. Simply, for five geographical locations, the total number of simulation cases is 5×1600, or 8000 cases to determine 8000 EUIs. Each simulation case may return EUIs by sub-use (e.g., there are three sub-uses in the present embodiments: (1) lighting, (2) heating, and (3) cooling), so that 8000 cases will return 3×8000 EUIs by sub-use. By using discrete entries (e.g., choices) of the space-type attribute entries, the total number of cases may be determined and may be limited, if desired. In accordance with embodiments of the present system, this may minimize or otherwise reduce computational burdens and associated computational time. Further, this may allow for real time parameter changes (e.g., changing choices, etc.) without requiring undue computational time to determine results.

In accordance with embodiments of the present system, the computational workload to calculate the EUIs may be performed in an off-line environment. Accordingly, the scope of the building simulation tool may be expanded in a straight forward manner. For example, the simulation tool may be configured (e.g., in real time by a user, the system, etc.) to include additional or space-type attribute choices (e.g., c.f. Table 6) such as: (A) additional orientation choices such as NE, NW, SE, SW (as opposed to N, E, S, W only); (B) additional building parameters choices (e.g. exterior wall insulation values (e.g., 1: R5; 2: R7; 3: R12; etc.); (C) additional WWR choices to include entries for selection of values such as 20%, 50%, etc.; including more glazing types (e.g., insulated glass, solar reflective glass, etc.); (D) additional use types (e.g., to address other types of buildings); and/or (E) additional ECM types (e.g., ECM4, ECM5, etc.). These changes to the space-type attribute choices may be made by the user and/or system and may be stored in a memory of the system for later use. Further, when these or other changes are made to the space-type attributes, the space-type decoupling table (e.g., see Table 6) may be updated to reflect these changes. Additionally, the UIs generated by the present system such as UI 500 may then reflect the changes to the space-type attribute choices.

Each additional space-type choice (e.g., NE in addition to N, S, E, and W) increases the number of simulations required to populate the EUI database. The simulation time for each case may vary and would increase as the number of space-type attribute choices is increased. The present system may be configured to automatically manage the creation of all necessary simulation files, manage the running of all simulations, and extract the EUI results. In some embodiments, a computational cluster may be used to exploit parallelism to decrease time required to perform the simulations.

Each simulation may build a corresponding EUI which may be stored in a memory of the system for later use in, for example, an EUI database. Thus, the EUI database may include all off-line computational results. After completing act 407, the process may continue to act 409.

During act 409, the process may build an energy calculation tool (ECT) around the EUI database. Thus, assuming that the user has input the following information via the UI (e.g., UI 500) for each space of a plurality of spaces of the building (e.g., areas of a plurality of areas of the building):

Area Name: <A01> (space)
Square footage: <X_{A01}>
Floor
Zone-type
If perimeter, WWR
If perimeter, Glazing
Use-type

Area Name: <A02>
Etc.

Given these inputs for each area (space) of the building, the EUI selector may select the appropriate EUIs to use for the energy consumption calculations. For example, in accordance with some embodiments, the system may provide a user with multiple choices which may be selected for each space-type attribute, where each of those multiple choices may correspond to the corresponding space-type attribute choices used in simulating the EUIs. The user may be expected to select one or more choices which may be considered by the user to be a “closest match” to characteristics of the corresponding building area or areas for the space-type attributes. In yet other embodiments, a user may enter space-type attributes for the corresponding building areas and either: 1) the selector chooses the EUI that most closely matches (e.g., in accordance with an error minimization algorithm, etc.) or 2) the selector may employ an interpolation method to generate new EUIs that are not in the EUI database. For example, assuming that EUI01 may correspond to various parameters including a WWR of 33% and EUI02 may correspond to the same various parameters except that it has a WWR of 66%. Then, assuming that the actual building space has a WWR of 50%, EUI03 may be generated as a linear (or other) interpolation between EUI01 and EUI02 to approximate a WWR of 50%. In multiple dimensions, a nearest neighbor or other interpolation method may be employed by the system.

An energy aggregator may calculate energy consumption estimates for the whole building by multiplying the space square area (e.g., area² for each space of the plurality of spaces of the building) by the appropriate EUI for that space, and then summing all results. The process may then determine annual energy consumption for different cases such as those listed below.

An example calculation for the base case scenario:

Annual Energy Consumption_{Base}=X_{A01}EUI_{A01,Base}+X_{A02}EUI_{A02,Base}+ . . . Eq. (18)

Similar calculations are then performed for each ECM:

Annual Energy Consumption_{ECM1}=X_{A01}EUI_{A01,ECM1}+X_{A02}EUI_{A02,ECM1}+ . . . Eq. (19)

The energy consumption calculations may be broken down by sub-use, for example by lighting, cooling, and heating:

Annual Energy Consumption_{ECM1,Lighting}=X_{A01}EUI_{A01,ECM1,Lighting}+X_{A02}EUI_{A02,ECM1,Lighting}+ . . . Eq. (20)

Annual Energy Consumption_{ECM1,Cooling}=X_{A01}EUI_{A01,ECM1,Cooling}+X_{A02}EUI_{A02,ECM1,Cooling}+ . . . Eq. (21)

Annual Energy Consumption_{ECM1,Heating}=X_{A01}EUI_{A01,ECM1,Heating}+X_{A02}EUI_{A02,ECM1,Heating}+ . . . Eq. (22)

Flexibility may be determined by the population of the EUI database. The database may be expanded to incorporate new parameters (e.g., space-type attribute choices), ECMs, and/or combinations of ECMs.

This implementation describes an energy conservation process and method where the user inputs are limited to combinations of discrete choices used to populate the EUI database. The EUI selector may have the intelligence to allow the user to input values (for instance, of WWR) that may not match exactly with the EUIs, but interpolation may be used between the nearest neighbor EUIs to estimate results for an in-between parameter. For instance, if EUIs in the database have been calculated for WWR 20% and WWR 40%, but the user enters WWR 30%, then simple linear interpolation may be used to interpolate results for lighting, heating, and cooling energy for various ECMs. Linear interpolation would not significantly impact the calculation time of the ECT. After completing act 409, the process may continue to act 411.

During act 411, the process may render results of the process for the convenience of the user. Accordingly, the process may generate a user interface (UI) which may include results of the process to be rendered and/or a menu system in which the user may interact with the system to obtain further analysis and/or to tweak the results. The UI may then be rendered on, for example, a display of the system. However, in yet other embodiments, the results may be printed or may be stored as a file in a desired format (e.g., pdf), if desired. With regard to displaying the results, FIG. 6 shows a user interface 600 including results of the process and rendered on a display in accordance with embodiments of the present system. The results may include a menu 602 including information such as the baseline energy consumption, expected energy savings for each ECM, ranking of the ECMs (e.g., “ECM 2 is the most cost and energy efficient and is expected to save $ Z watts/m² annually and at current electrical rates this may result in an annual savings of $Y.”) The process may further use an ECM comparator which may provide an estimate of implementation cost for each ECM in, for example, a side-by-side manner, if desired. Moreover, the process may provide other financial analysis determined by the process such as a time period during which the initial costs to implement the ECM are expected to be returned due to cost savings of the corresponding ECM. This information may be displayed as “return on initial investment=two weeks.” After completing act 411, the process may continue to act 413.

During act 413, the process may form and/or update building history information in accordance with results of the process and/or any user inputs. The building history information may be stored in a memory of the system for later use. After completing act 413, the process may continue to act 415, where it ends.

FIG. 7 shows a portion of a system 700 in accordance with an embodiment of the present system. For example, a portion of the present system 700 may include a processor 710 (e.g., a controller) operationally coupled to a memory 720, a user interface 730, sensors 760, and a user input device 770. The memory 720 may be any type of device for storing application data as well as other data related to the described operation. The application data and other data are received by the processor 710 for configuring (e.g., programming) the processor 710 to perform operation acts in accordance with the present system. The processor 710 so configured becomes a special purpose machine particularly suited for performing in accordance with embodiments of the present system.

The operation acts may include configuring the system 700 by, for example, the processor 710 to obtain information from user inputs, the sensors 760, and/or the memory 720 and processing this information in accordance with embodiments of the present system to obtain information related to energy use and which may form at least part of content. The user input portion 770 may include a keyboard, mouse, trackball or other device, including touch-sensitive displays, which may be stand alone or be a part of a system, such as part of a personal computer, a smart phone, a personal digital assistant (PDA), a mobile phone, or other device for communicating with the processor 710 via any operable link. The user input portion 770 may be operable for interacting with the processor 710 including enabling interaction within a UI as described herein. Clearly the processor 710, the memory 720, the UI 730 and/or user input device 770 may all or partly be a portion of a computer system or other device as described herein.

Further, the content may then be stored in a memory of the system such as the memory 720 for later use and/or processing in accordance with embodiments of the present system. Thus, operation acts may include requesting, providing, and/or rendering of content such as, for example, information related to energy use of a building. The processor 710 may render the content on the UI 730 such as on a display of the system. The sensors may include suitable sensors to provide desired sensor information to the processor 710 for further processing in accordance with embodiments of the present system.

The methods of the present system are particularly suited to be carried out by a computer software program, such program containing modules corresponding to one or more of the individual steps or acts described and/or envisioned by the present system. Such program may of course be embodied in a computer-readable medium, such as an integrated chip, a peripheral device or memory, such as the memory 720 or other memory coupled to the processor 710.

The program and/or program portions contained in the memory 720 configure the processor 710 to implement the methods, operational acts, and functions disclosed herein. The memories may be distributed, for example between the clients and/or servers, or local, and the processor 710, where additional processors may be provided, may also be distributed or may be singular. The memories may be implemented as electrical, magnetic or optical memory, or any combination of these or other types of storage devices. Moreover, the term “memory” should be construed broadly enough to encompass any information able to be read from or written to an address in an addressable space accessible by the processor 710. With this definition, information accessible through a network is still within the memory, for instance, because the processor 710 may retrieve the information from the network for operation in accordance with the present system.

The processor 710 is operable for providing control signals and/or performing operations in response to input signals from the user input device 770 as well as in response to other devices of a network and executing instructions stored in the memory 720. For example, the processors 710 may obtain feedback information from the sensors 740 and may process this information to determine energy conservation information. The processor 710 may include one or more of a microprocessor, an application-specific or general-use integrated circuit(s), a logic device, etc. Further, the processor 710 may be a dedicated processor for performing in accordance with the present system or may be a general-purpose processor wherein only one of many functions operates for performing in accordance with the present system. The processor 710 may operate utilizing a program portion, multiple program segments, or may be a hardware device utilizing a dedicated or multi-purpose integrated circuit.

Embodiments of the present system may be compatible with conventional sensors/loggers such as OccuSwitch™ Logger and the like and/or conventional simulation programs such as EnergyPlus™, ESP-r™, Autodesk Green Building Studio™, Integrated Environmental Solutions Virtual Environment™ and the like. The simulation programs may be configured in accordance with embodiments of the present system so as to be able to perform in accordance with one or more embodiments of the present system.

Accordingly, by locating sensors in accordance with embodiments of the present system, building energy use may be determined accurately and with sufficient granularity for any building. Further, embodiments of the present system may reduce quantities and/or types of sensors required to obtain sensor information. This may reduce installation time and/or costs when compared to conventional energy use sampling methods. As an example, to estimate the base lighting energy consumption in a building space and to estimate energy savings from occupancy-based switching and daylight dimming using embodiments of the present system, sensor may provide sensor information related to: lighting on status for certain lamps, dimming levels if applicable, occupancy status, and available daylight illumination for relevant areas of a building.

Thus, the present system may determine a number of sensors (e.g., Xtot) and/or placement of these sensors in a building having (Atot) areas where Xtot<<Atot while maintaining sufficient sampling by the sensors to characterize use and energy consumption for the entire building using one or more extrapolation techniques performed in accordance with embodiments of the present system. This enables a cost-effective, easily-implementable approach to sensor-based characterization of building use and energy consumption.

This invention proposes methods to acquire, process, and/or interpret sensory data from a limited number of sensors in order to produce estimates of energy consumption and energy savings potential for ECMs in an entire building. The size of the required sensor installation is then minimized, is cost-effective, and is easily installed. Thus for a building where the number of sensors must be minimized (for cost and implementation issues), or if there is an explicit constraint on number of sensors or cost of sensors, the deployment of the sensors in the building may be optimized in order to accurately characterize the use and energy consumption of the entire building.

Finally, the above-discussion is intended to be merely illustrative of the present system and should not be construed as limiting the appended claims to any particular embodiment or group of embodiments. Thus, while the present system has been described with reference to exemplary embodiments, it should also be appreciated that numerous modifications and alternative embodiments may be devised by those having ordinary skill in the art without departing from the broader and intended spirit and scope of the present system as set forth in the claims that follow. Accordingly, the specification and drawings are to be regarded in an illustrative manner and are not intended to limit the scope of the appended claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) any of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise;

h) no specific sequence of acts or steps is intended to be required unless specifically indicated; and

i) the term “plurality of” an element includes two or more of the claimed element, and does not imply any particular range of number of elements; that is, a plurality of elements may be as few as two elements, and may include an immeasurable number of elements.

1. A system, comprising:
a controller configured to:
obtain space attribute information (SAI) comprising information related to identity (ID), use type, square area (area²), occupant density, and daylight illumination for a plurality of spaces of the building;
cluster the plurality of spaces into two or more classes based on energy consumption and energy savings potentials of each of the plurality of spaces determined from a corresponding SAI, wherein each class has class attributes which define the class;
determine a priority value for each of the two or more classes based upon a combination of SAI for each space in a class of the two or more classes; and
assign a plurality of sensors to a subset of the two or more classes in accordance with the determined priority value for each class, the one or more sensors are configured to detect one or more of occupancy, switch status, and light level information at the corresponding sensor and form corresponding sensor information.

2. The system of claim 1, wherein the controller is configured to determine a space of the plurality of spaces of the building to place each sensor of the plurality of sensors in accordance with at least the assignment of the plurality of sensors.

3. The system of claim 1, wherein the controller is configured to acquire the sensor information from each of the plurality of sensors.

4. The system of claim 3, wherein the controller is configured to determine baseline energy use information (BEUI) and energy savings information (ESI) for at least one energy conservation mode (ECM) for each class which is assigned one or more sensors based upon the received sensor information.

5. The system of claim 4, wherein the controller is configured to determine for each class that are assigned one or more sensors mean energy use density information (EUDI) and energy savings density information (ESDI) for the at least one ECM in accordance with the BEUI and the ESI for each class.

6. The system of claim 5, wherein the controller is configured to determine one or more of baseline energy consumption for the building and an energy savings for the at least one ECM for the building based upon at least one of the EMI and the ESDI.

7. A method of determining energy use in a building having a plurality of spaces each covering a square area (area²), the method performed by at least one controller and comprising acts of:
obtaining space attribute information (SAI) comprising information related to identity (ID), use type, square area, occupant density, and daylight illumination for each of the plurality of spaces of the building;
clustering each of the plurality of spaces into two or more classes based on energy consumption and energy savings potentials of each of the plurality of spaces determined from a corresponding SAI, wherein each class has class attributes which define the class;
determining a priority value for each of the two or more classes based upon a combination of SAI for each space in a class of the two or more classes; and
assigning a plurality of sensors to a subset of the two or more classes in accordance with the determined priority value for each class, the one or more sensors each configured to detect one or more of occupancy, switch status, and light level information in the vicinity of the corresponding sensor and form corresponding sensor information.

8. The method of claim 7, further comprising an act of determining a space of the plurality of spaces of the building to place each sensor of the plurality of sensors in accordance with at least the assignment of the plurality of sensors.

9. The method of claim 7, further comprising an act of acquiring sensor information from each of the plurality of sensors.

10. The method of claim 9, further comprising an act of determining baseline energy use information (BEUI) and energy savings information (ESI) for at least one energy conservation mode (ECM) for each class which is assigned one or more sensors based upon the acquired sensor information received from sensors assigned to each class.

11. The method of claim 10, further comprising an act of determining, for each class that are assigned one or more sensors, mean energy use density information (EUDI) and energy savings density information (ESDI) for the at least one ECM in accordance with at the BEUI and the ESI for each class.

12. The method of claim 11, further comprising an act of determining one or more of baseline energy consumption for the building and an energy savings for the at least one ECM for the building based upon at least one of the EUDI and the ESDI.

13. A computer program stored on a computer readable memory medium, the computer program configured to generate information indicative of energy use in a building having a plurality of spaces each having a square area (area²), the computer program comprising:
a program portion configured to:
obtain space attribute information (SAI) comprising information related to identity (ID), use type, square area, occupant density, and daylight illumination for each of the plurality of spaces of the building;
cluster each of the plurality of spaces into two or more classes based on energy consumption and energy savings potentials of each of the plurality of spaces determined from a corresponding SAI, wherein each class has class attributes which define the class;
determine a priority value for each of the one or more classes based upon a combination of SAI for each space in a class of the two or more classes; and
assign a plurality of sensors to a subset of the two or more classes in accordance with the determined priority value for each class, the one or more sensors each configured to detect one or more of occupancy, switch status, and light level information in the vicinity of the corresponding sensor and form corresponding sensor information.

14. The computer program of claim 13, wherein the program portion is further configured to determine a space of the plurality of spaces of the building to place each sensor of the plurality of sensors in accordance with at least the assignment of the plurality of sensors.

15. The computer program of claim 13, wherein the program portion is further configured to acquire sensor information from each of the plurality of sensors.

16. The computer program of claim 15, wherein the program portion is further configured to determine baseline energy use information (BETA) and energy savings information (ESI) for at least one energy conservation mode (ECM) for each class which is assigned one or more sensors based upon the received sensor information received from sensors assigned to each class.

17. The computer program of claim 16, wherein the program portion is further configured to determine, for each class that are assigned one or more sensors, mean energy use density information (EUDI) and energy savings density information (ESDI) for the at least one ECM in accordance with at the BEUI and the EST for each class.

18. The computer program of claim 17, wherein the program portion is further configured to determine one or more of baseline energy consumption for the building and an energy savings for the at least one ECM for the building based upon at least one of the EUDI and the ESDI.

19. A system, comprising:
at least one controller which is configured to:
obtain space-type attribute information (STI) comprising information related to floor type, zone type, window/wall ratio (WWR), glazing type, use type, and desired energy conservation mode (ECM) for a plurality of spaces in a building, each of the plurality of spaces covering a corresponding square area of space in the building;
determine one or more of occupancy, lighting, and plug load profiles for the STI for each of the plurality of spaces;
cluster the plurality of spaces into two or more classes based on energy consumption and energy savings potentials of each of the plurality of spaces determined from a corresponding STI and the determined one or more of occupancy, lighting, and plug load profiles for each of the plurality of spaces, wherein each class has class attributes which define the class;
determine a priority value for each of the two or more classes based upon a combination of STI and the determined one or more of occupancy, lighting, and plug load profiles for each space in a class of the two or more classes; and
assign a plurality of sensors to a subset of the two or more classes in accordance with the determined priority value for each class, the one or more sensors are configured to detect one or more of occupancy, switch status, and light level information at the corresponding sensor and form corresponding sensor information;
determine baseline energy use information (BEUI) and energy savings information (ESI) for at least one energy conservation mode (ECM) for each class which is assigned one or more sensors based upon the received sensor information;
build energy use index (EUI) models in accordance with BEUI to represent base energy use and a ECM for the plurality of spaces of the building;
select an EUI for each space from the EUI models based upon a selected space type attribute choice for each corresponding space;
determine energy consumption for the spaces by multiplying the selected EUI for each space by the square area of the corresponding space of the plurality of spaces; and
estimate energy consumption for the building based upon a summation of the determined energy consumption for the plurality of spaces.
